(19) United States
(12) Patent Application Publication
(10) Pub. No.: US 2025/0144991 A1
(43) Pub. Date: May 8, 2025

(54) Retractable Headlight Cover

(71) Applicant: Karma Automotive LLC, Irvine, CA (US)

(72) Inventor: Nicholas David, Irvine, CA (US)

(73) Assignee: Karma Automotive LLC, Irvine, CA (US)

(21) Appl. No.: 18/932,579

(22) Filed: Oct. 30, 2024

Related U.S. Application Data
(60) Provisional application No. 63/596,789, filed on Nov. 7, 2023.

(51) Int. Cl. B60J 11/06; B60Q 1/04; B60Q 1/18

(52) U.S. Cl. CPC B60J 11/06; B60Q 1/0408; B60Q 1/18

(57) ABSTRACT

A vehicular headlight system includes a headlight configured to mount at a vehicle equipped with the vehicular headlight system. The headlight includes a lens and a light source that, with the headlight mounted at the vehicle and, when the light source is electrically operated, emits light through the lens to illuminate a region forward of the vehicle. The vehicular headlight system includes a cover that, with the headlight mounted at the vehicle, is movable relative to the headlight between a deployed position and a retracted position. When the cover is in the deployed position, the cover extends over and along the lens of the headlight so that the headlight is not viewable. When the cover is in the retracted position, the cover is moved laterally away and inboard of the headlight so that the headlight is viewable.

### CROSS-REFERENCE TO RELATED APPLICATIONS

This U.S. patent application claims priority under 35 U.S.C. § 119(e) to U.S. Provisional Application 63/596,789, filed on Nov. 7, 2023. The disclosure of this prior application is considered part of the disclosure of this application and is hereby incorporated by reference in its entirety.

### TECHNICAL FIELD

This disclosure relates to a retractable headlight cover for a vehicle.

### BACKGROUND

It is known to equip a vehicle with hidden headlights where, when the headlights are not being operated to illuminate an area forward of the vehicle, the headlights are hidden from view, and when the headlights are being operated to illuminate the area forward of the vehicle, the headlights are revealed and exposed for viewing. For example, traditional hidden headlights include pop-up style headlights mounted in a housing that rotates or tilts downward into a recessed portion of the body of the vehicle to hide the headlight and to appear flush with the vehicle body when not being operated and that rotates or tilts upward to extend or protrude from the vehicle body and present the headlight exterior the vehicle when being operated. Another example of a known hidden headlight mounts the headlight to a rotating panel that rotates or pivots to move the headlights behind the grill or front fascia of the vehicle.

Hidden headlights have become less popular in modern vehicles as traditional designs present added cost, weight, and need for maintenance. Further, pop-up style headlights, and other designs that cause the headlight assembly to protrude from the vehicle body when the headlights are being operated, are discouraged by modern safety regulations and create aerodynamic inefficiencies.

### SUMMARY

One aspect of the disclosure provides a vehicular headlight system. The vehicular headlight system includes a headlight configured to mount at a vehicle equipped with the vehicular headlight system. The headlight includes a lens and a light source that, with the headlight mounted at the vehicle and, when the light source is electrically operated, emits light through the lens to illuminate a region forward of the vehicle. The vehicular headlight system includes a cover that, with the headlight mounted at the vehicle, is movable relative to the headlight between a deployed position and a retracted position. When the cover is in the deployed position, the cover extends over and along the lens of the headlight so that the headlight is not viewable. When the cover is in the retracted position, the cover is moved laterally away and inboard of the headlight so that the headlight is viewable.

Implementations of the disclosure may include one or more of the following optional features. In some implementations, with the cover in the deployed position, an outer surface of the cover is substantially flush with an outer surface of a body portion of the vehicle at or near the headlight. In further implementations, when the cover is moved from the deployed position to the retracted position, the cover is moved toward the headlight and moved laterally away from the headlight behind the body portion of the vehicle. In some further implementations, the body portion of the vehicle includes a hood of the vehicle.

In some examples, the cover is laterally movable relative to the headlight along a track. In further examples, when the cover is moved from the deployed position to the retracted position, the track is moved toward the headlight to move the cover toward the headlight and the cover is moved laterally along the track away and inboard of the headlight.

In some aspects, when the light source is electrically operated, the cover is in the retracted position. When the light source is not electrically operated, the cover is in the deployed position.

The cover may be moved from the deployed position to the retracted position in response to the headlight being electrically operated. Optionally, the cover is movable between the deployed position and the retracted position based on a user actuatable input.

In some implementations, with the headlight mounted at the vehicle, a daytime running light is mounted at the vehicle near the headlight. The daytime running light is viewable when the cover is in the deployed position and the retracted position.

Another aspect of the disclosure provides a vehicle. The vehicle includes a headlight. The headlight includes a lens and a light source that, when the light source is electrically operated, emits light through the lens to illuminate a region forward of the vehicle. The vehicle includes a cover that is movable relative to the headlight between a deployed position and a retracted position. When the cover is in the deployed position, the cover extends over and along the lens of the headlight so that the headlight is not viewable. When the cover is in the retracted position, the cover is moved laterally away and inboard of the headlight so that the headlight is viewable. This aspect may include one or more of the following optional features.

In some implementations, with the cover in the deployed position, an outer surface of the cover is substantially flush with an outer surface of a body portion of the vehicle at or near the headlight. In further implementations, when the cover is moved from the deployed position to the retracted position, the cover is moved toward the headlight and moved laterally away from the headlight behind the body portion of the vehicle. In some further implementations, the body portion of the vehicle includes a hood of the vehicle.

In some examples, the cover is laterally movable relative to the headlight along a track. In further examples, when the cover is moved from the deployed position to the retracted position, the track is moved toward the headlight to move the cover toward the headlight and the cover is moved laterally along the track away and inboard of the headlight.

In some aspects, when the light source is electrically operated, the cover is in the retracted position. When the light source is not electrically operated, the cover is in the deployed position.

The cover may be moved from the deployed position to the retracted position in response to the headlight being electrically operated. Optionally, the cover is movable between the deployed position and the retracted position based on a user actuatable input.

In some implementations, a daytime running light is mounted at the vehicle near the headlight. The daytime running light is viewable when the cover is in the deployed position and the retracted position.

An additional aspect of the disclosure provides a computer-implemented method that when executed on data processing hardware causes the data processing hardware to perform operations. The operations include moving a cover from a deployed position, where the cover extends over and along a lens of a headlight mounted at a vehicle so that the headlight is not viewable, to a retracted position, where the cover is moved laterally away and inboard of the headlight so that the headlight is viewable. With the cover in the retracted position, the operations include electrically operating a light source of the headlight. The light source, when electrically operated, emits light through the lens to illuminate a region forward of the vehicle. This aspect may include one or more of the following optional features.

In some implementations, with the cover in the deployed position, an outer surface of the cover is substantially flush with an outer surface of a body portion of the vehicle at or near the headlight. In further implementations, moving the cover from the deployed position to the retracted position includes moving the cover toward the headlight and laterally away from the headlight behind the body portion of the vehicle. In some further implementations, the body portion of the vehicle includes a hood of the vehicle.

In some examples, the cover moves relative to the headlight along a track. In further examples, moving the cover from the deployed position to the retracted position includes moving the track toward the headlight to move the cover toward the headlight and moving the cover laterally along the track away and inboard of the headlight.

Optionally, with the cover in the deployed position, the light source is not electrically operated. Moving the cover from the deployed position to the retracted position may be in response to the headlight being electrically operated. Moving the cover from the deployed position to the retracted position may be based on a user actuatable input.

In some aspects, the vehicle includes a daytime running light mounted at the vehicle near the headlight. The daytime running light is viewable when the cover is in the deployed position and the retracted position.

Yet another aspect of the disclosure provides a system. The system includes data processing hardware and memory hardware in communication with the data processing hardware. The memory hardware stores instructions that when executed on the data processing hardware cause the data processing hardware to perform operations.

The operations include moving a cover from a deployed position, where the cover extends over and along a lens of a headlight mounted at a vehicle so that the headlight is not viewable, to a retracted position, where the cover is moved laterally away and inboard of the headlight so that the headlight is viewable. With the cover in the retracted position, the operations include electrically operating a light source of the headlight. The light source, when electrically operated, emits light through the lens to illuminate a region forward of the vehicle. This aspect may include one or more of the following optional features.

In some implementations, with the cover in the deployed position, an outer surface of the cover is substantially flush with an outer surface of a body portion of the vehicle at or near the headlight. In further implementations, moving the cover from the deployed position to the retracted position includes moving the cover toward the headlight and laterally away from the headlight behind the body portion of the vehicle. In some further implementations, the body portion of the vehicle includes a hood of the vehicle.

In some examples, the cover moves relative to the headlight along a track. In further examples, moving the cover from the deployed position to the retracted position includes moving the track toward the headlight to move the cover toward the headlight and moving the cover laterally along the track away and inboard of the headlight.

Optionally, with the cover in the deployed position, the light source is not electrically operated. Moving the cover from the deployed position to the retracted position may be in response to the headlight being electrically operated. Moving the cover from the deployed position to the retracted position may be based on a user actuatable input.

In some aspects, the vehicle includes a daytime running light mounted at the vehicle near the headlight. The daytime running light is viewable when the cover is in the deployed position and the retracted position.

The details of one or more implementations of the disclosure are set forth in the accompanying drawings and the description below. Other aspects, features, and advantages will be apparent from the description and drawings, and from the claims.

### DESCRIPTION OF DRAWINGS

FIG. 1A is a perspective view of a vehicle with a set of retractable headlight covers in a retracted position to expose the headlights and allow the headlights to illuminate an area forward of the vehicle.

FIG. 1B is a perspective view of the vehicle of FIG. 1A with the set of retractable headlight covers in a deployed position to cover and hide the headlights when the headlights are not being used to illuminate the area forward of the vehicle.

FIG. 2A is another perspective view of the vehicle of FIG. 1A with the set of retractable headlight covers in the retracted position.

FIG. 2B is another perspective view of the vehicle of FIG. 1A with the set of retractable headlight covers in the deployed position.

FIG. 3A is an enlarged view of a headlight region of the vehicle of FIG. 1A with a retractable headlight cover in the retracted position and a hood of the vehicle removed to show the headlight cover retracted away from the headlight.

FIG. 3B is an enlarged view of the headlight region of the vehicle of FIG. 1A with a retractable headlight cover in the deployed position and a hood of the vehicle removed.

FIG. 4A is another enlarged view of a headlight region of the vehicle of FIG. 1A with a retractable headlight cover in the retracted position.

FIG. 4B is another enlarged view of the headlight region of the vehicle of FIG. 1A with a set retractable headlight cover in the deployed position.

FIG. 5A is a top perspective view of the vehicle of FIG. 1A with the set of retractable headlight covers in the retracted position.

FIG. 5B is a top perspective view of the vehicle of FIG. 1A with the set of retractable headlight covers in the deployed position.

FIG. 6A is a front perspective view of the vehicle of FIG. 1A with the set of retractable headlight covers in the retracted position.

FIG. 6B is a front perspective view of the vehicle of FIG. 1A with the set of retractable headlight covers in the deployed position.

FIG. 7A is a side perspective view of the vehicle with the set of retractable headlight covers in the retracted position.

FIG. 7B is a side perspective view of the vehicle of FIG. 1A with the set of retractable headlight covers in the retracted position.

FIG. 8A is another side perspective view of the vehicle of FIG. 1A with the set of retractable headlight covers in the retracted position.

FIG. 8B is another side perspective view of the vehicle of FIG. 1A with the set of retractable headlight covers in the retracted position.

FIG. 9A is a front perspective view of the vehicle of FIG. 1A with the set of retractable headlight covers in the retracted position.

FIG. 9B is a front perspective view of the vehicle of FIG. 1A with the set of retractable headlight covers in the retracted position.

FIG. 10A is a top perspective view of the vehicle of FIG. 1A with the set of retractable headlight covers in the retracted position.

FIG. 10B is a top perspective view of the vehicle of FIG. 1A with the set of retractable headlight covers in the retracted position.

FIG. 11 is a flowchart of an example method of controlling operation of the set of retractable headlight covers and the headlights of the vehicle.

Like reference symbols in the various drawings indicate like elements.

### DETAILED DESCRIPTION

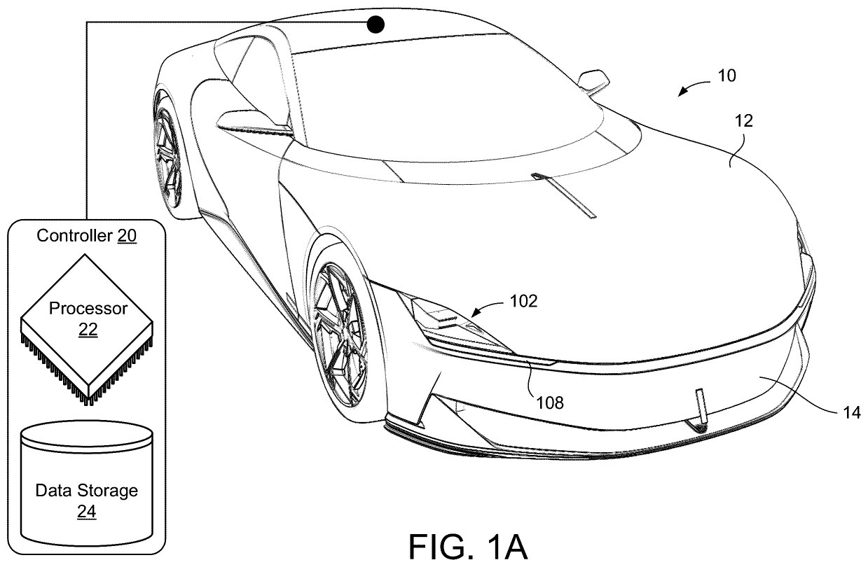

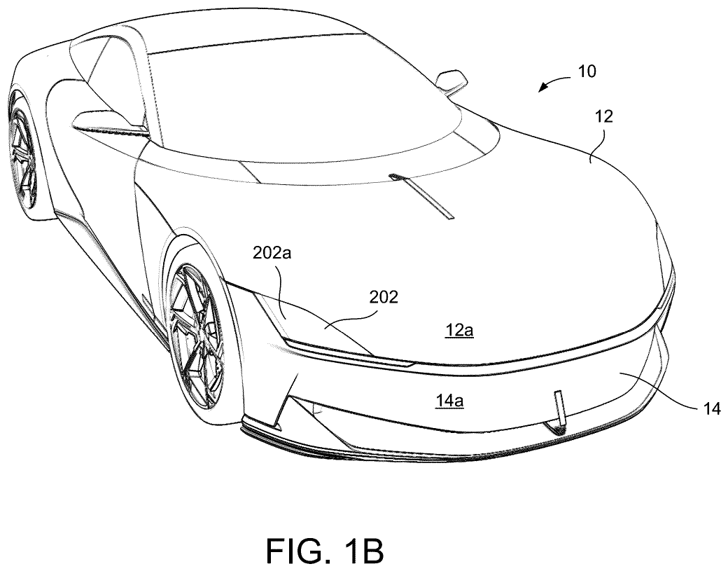

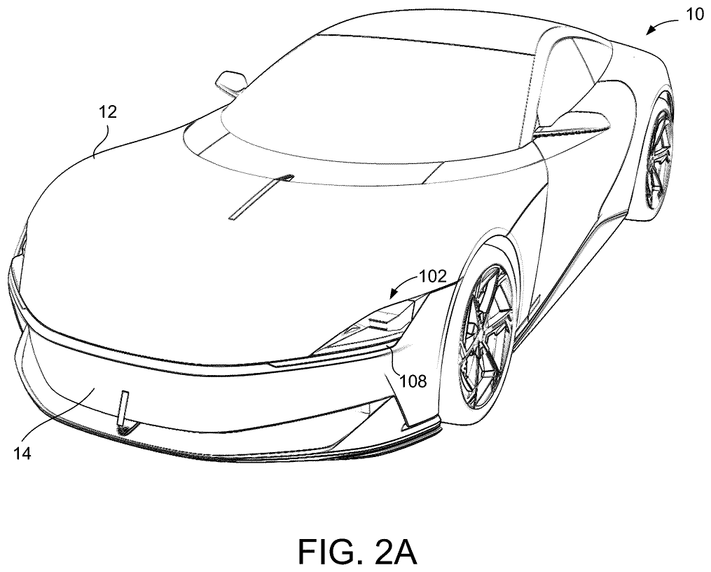

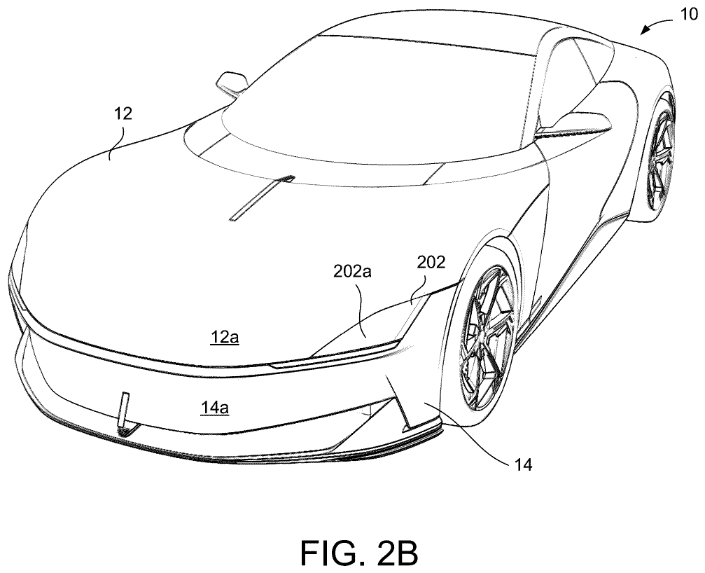

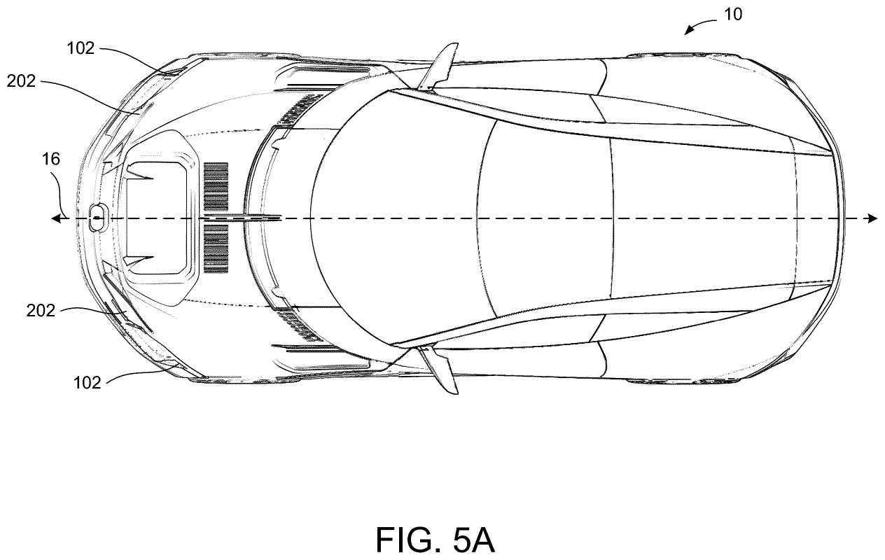

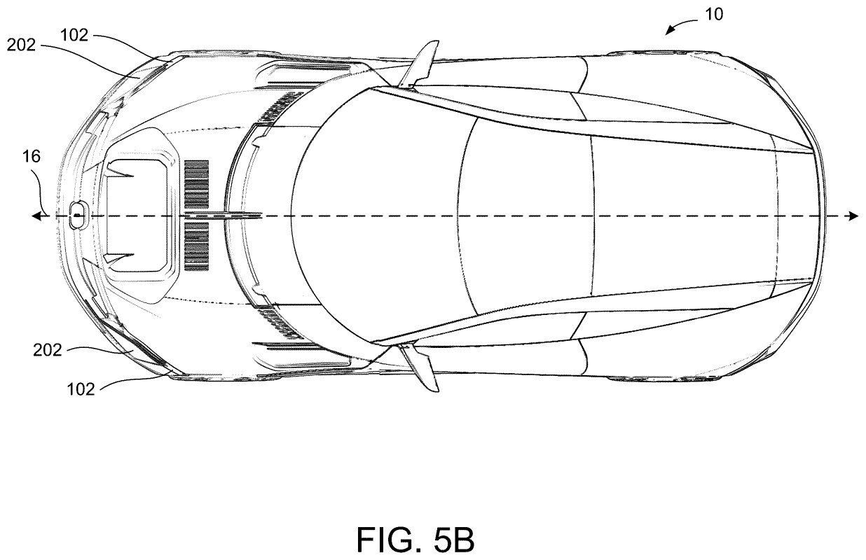

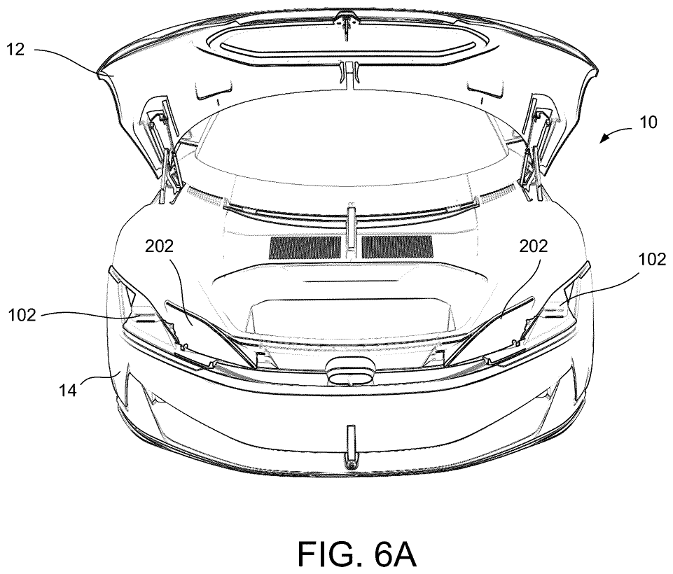

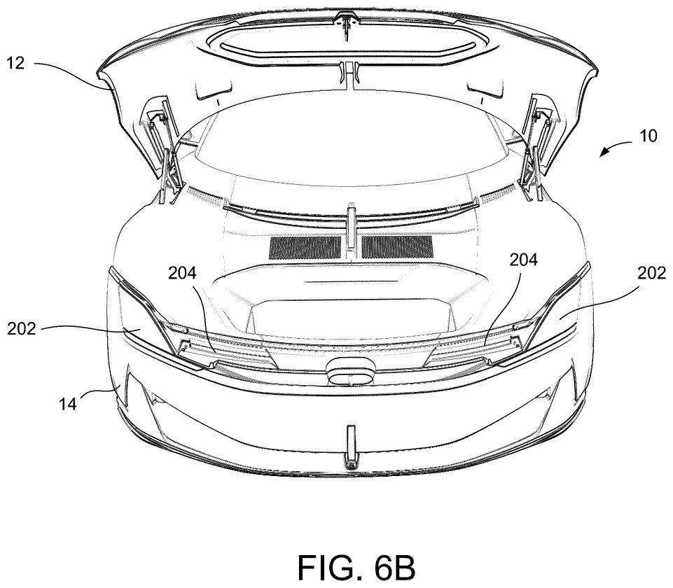

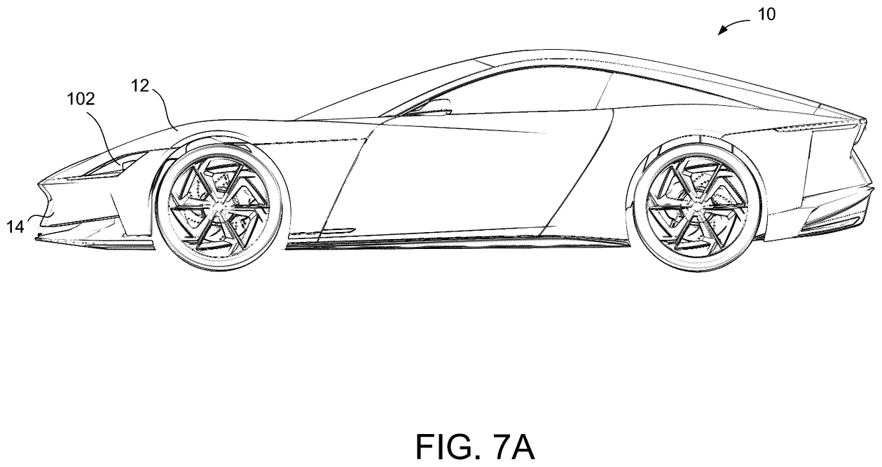

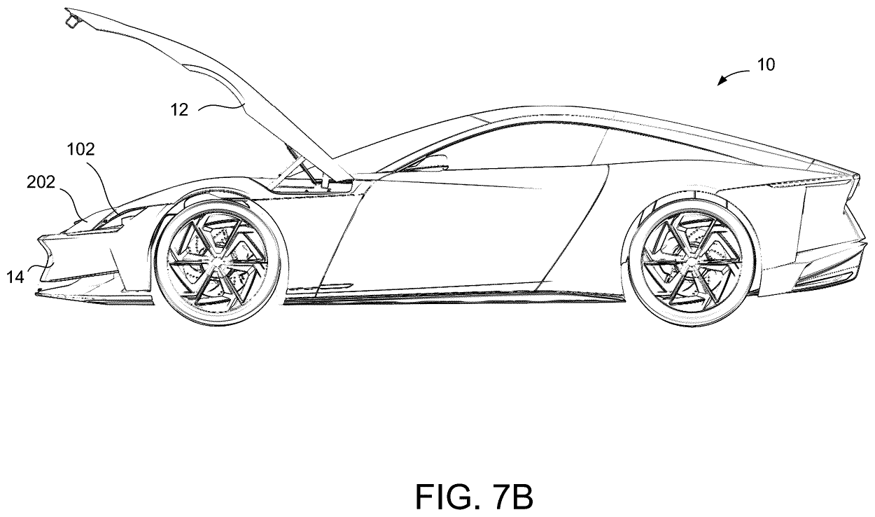

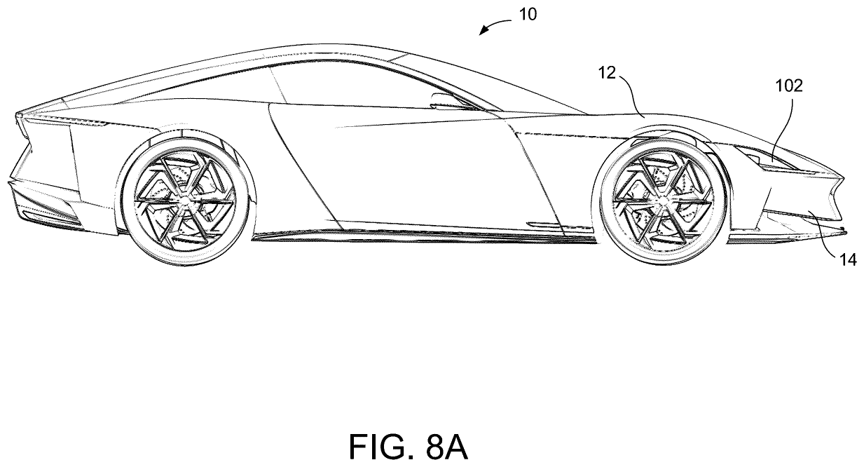

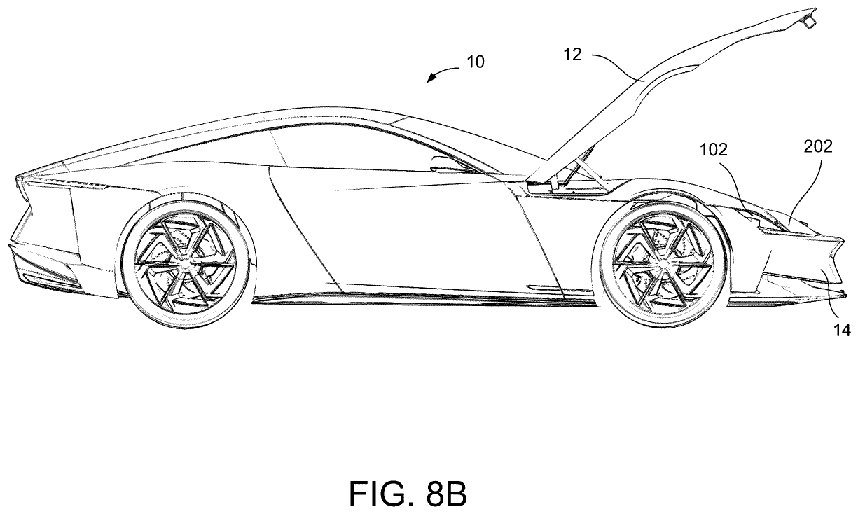

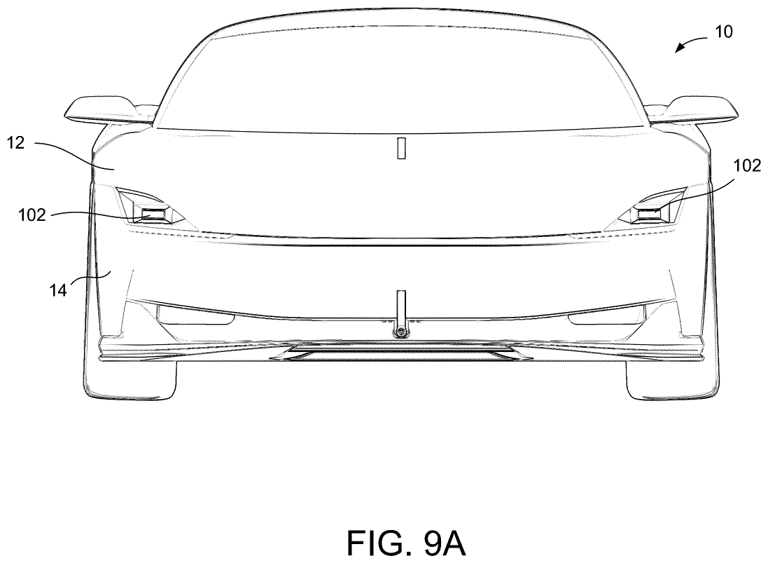

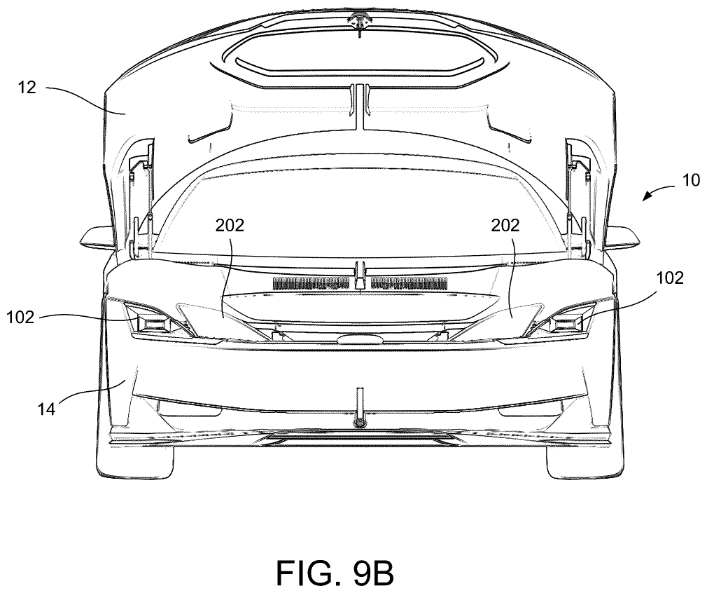

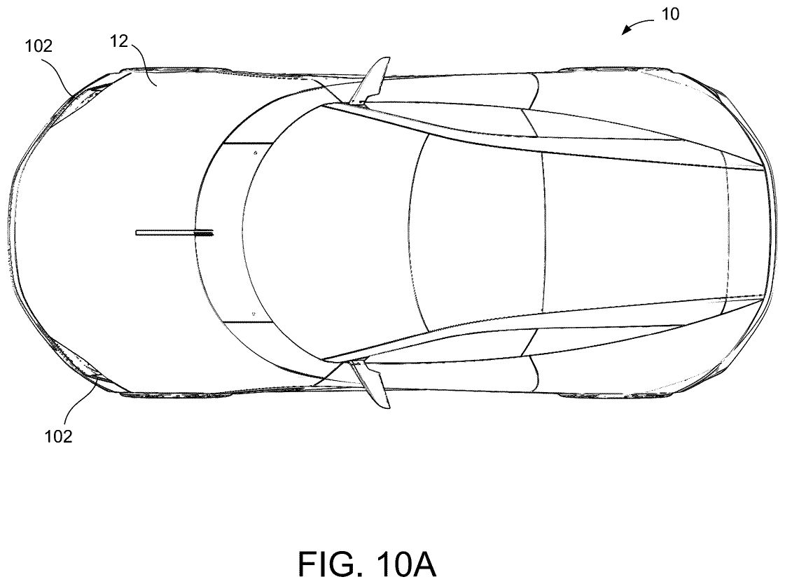

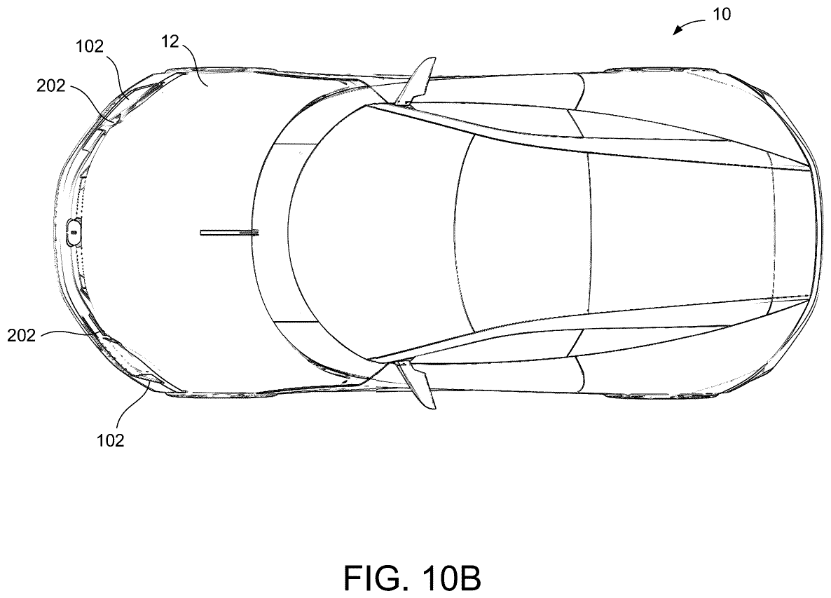

Referring to FIGS. 1A-10B, a vehicle 10, such as a battery powered vehicle like a an electric vehicle (EV) or plug-in hybrid vehicle (PHEV), includes a hidden headlight system 100 that is configured to hide or cover the headlights 102 of the vehicle 10 when the headlights 102 are not being operated and that is configured to reveal or expose the headlights 102 when the headlights 102 are being operated to illuminate a region forward of the vehicle 10. As described further below, the headlight system 100 includes a set of headlight covers (interchangeably referred to as “headlight doors”) 202, where each cover 202 of the set of covers 202 is movable relative to a respective headlight 102 between a retracted position (FIGS. 1A and 2A) and a deployed position (FIGS. 1B and 2B). That is, in the illustrated example, the vehicle 10 includes headlights 102 respectively at the driver-side of the vehicle 10 and at the passenger-side of the vehicle 10 and a respective cover 202 is movable between the deployed position and the retracted position to hide and reveal each headlight 102.

The headlights 102 may include characteristics of any headlight suitable to be mounted at the vehicle 10 and electrically operated to emit light and illuminate the region forward of the vehicle 10. In the illustrated example, each headlight 102 includes a light source 104, such as one or more halogen bulbs, light emitting diodes (LEDs), xenon or high-intensity discharge (HID) bulbs, laser light sources and the like, and a lens 106. When the headlight 102 is electrically operated, the light source 104 emits light through the lens 106 to illuminate the region forward of the vehicle 10. In some examples, the light source 104 is accommodated between the lens 106 and a housing of the headlight 102, with the housing mounted to the vehicle.

Each headlight 102 is mounted relative to a body portion or surface of the vehicle 10 so that, when the cover 202 is in the deployed position, an outer surface 202a of the cover 202 is generally flush with or corresponds to an outer surface of the body portion of the vehicle 10 at or near the headlight 102. In the illustrated example, the headlight 102 is mounted between an edge of a hood or bonnet 12 of the vehicle 10 and a front bumper or front fascia 14 of the vehicle 10. Thus, with the cover 202 in the deployed position, the outer surface 202a of the cover 202 is substantially flush with or corresponds to an outer surface 12a of the hood 12 and/or an outer surface 14a of the front fascia 14 at or near the headlight 102.

When the set of covers 202 are in the deployed position, each cover 202 extends over and along the lens 106 of the respective headlight 102 so that the headlights 102 are not visible to a person viewing the exterior of the vehicle 10. This provides an improved aesthetic for the vehicle 10 when the headlights 102 are not being operated. When the set of covers 202 are in the retracted position, each cover 202 is moved laterally away from the respective headlight 102 and inboard of the headlight 102 toward a center of the vehicle bisected by a longitudinal axis 16 of the vehicle 10 so that each headlight 102 is visible to a person viewing the exterior of the vehicle 10. Thus, the covers 202 move laterally inboard toward one another. This allows the headlights 102 to emit light to illuminate the region forward of the vehicle with the covers 202 moved out of the path of illumination of the headlights 102.

Further, when the cover 202 is moved from the deployed position to the retracted position, the cover 202 is moved behind or within a body portion of the vehicle 10 to hide or conceal the covers 202 during operation of the headlights 102. In the illustrated example, the covers 202 are moved inboard of the headlights 102 and behind a forward portion of the hood 12 of the vehicle 10 so that the covers 202 are not visible to a person viewing the exterior of the vehicle 10.

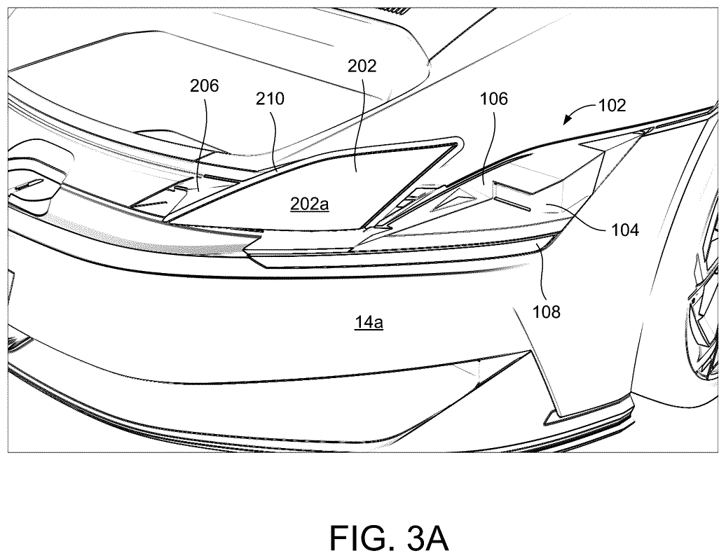

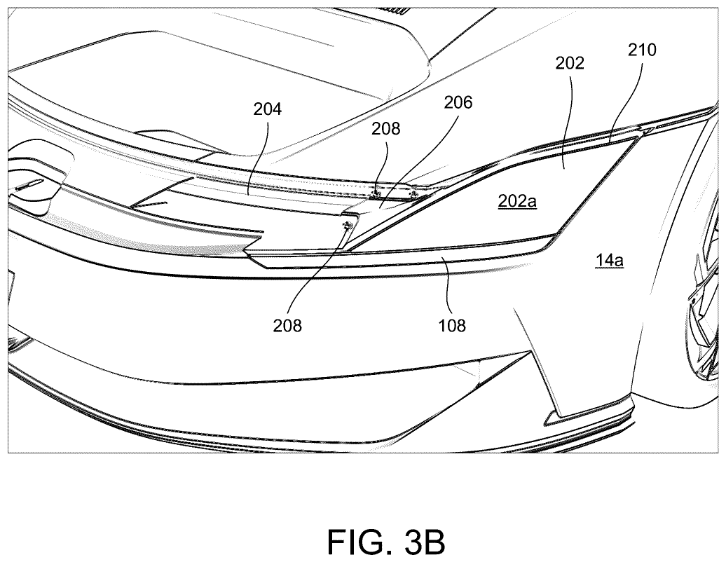

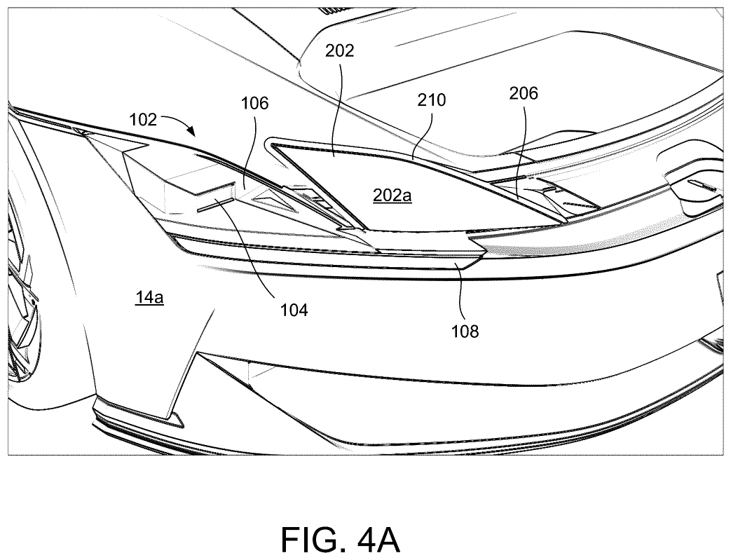

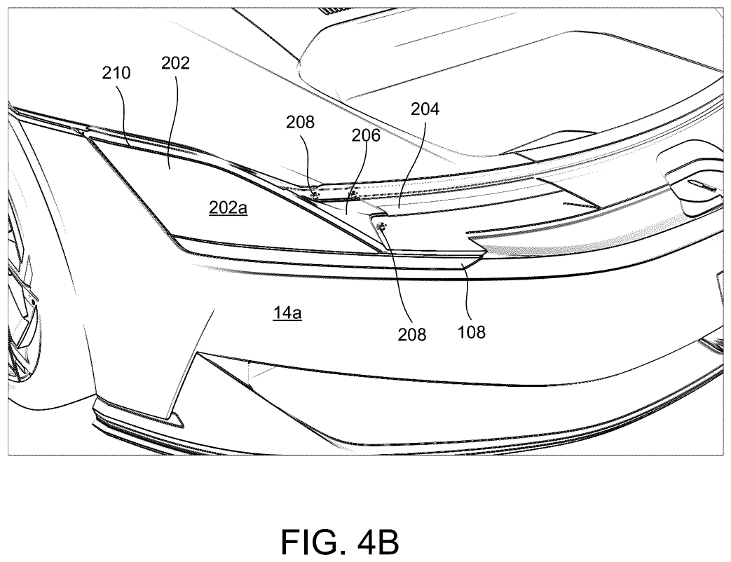

Referring to FIGS. 3A-4B, each cover 202 is laterally movable relative to the respective headlight 102 along a track or rail 204. For example, a wing or attachment portion or trolley 206 is movably received along the track 204, with the cover 202 extending from the trolley 206. The track 204 may include an outboard end disposed at or near the headlight 102 and an inboard end opposite the outboard end disposed behind the hood 12 of the vehicle 10. Thus, when the cover 202 is in the deployed position (FIGS. 3B and 4B), the trolley 206 is at or near the laterally outboard end of the track 204 with the cover 202 extending from the trolley 206 and over and along the lens 106 of the headlight 102. When the cover 202 is in the retracted position (FIGS. 3A and 4A), the trolley 206 is at or near the laterally inboard end of the track 204 with the cover 202 extending from the trolley 206 and behind the hood 12 of the vehicle 10. One or more wheels 208 are disposed between the trolley 206 and opposing sides of the track 204 to enable movement of the trolley 206 along the track 204. Notably, the depiction of the covers while in the retracted position is shown in FIGS. 3A and 4A for illustrative purposes only, whereby the covers 202 are hidden from view behind the hood 12.

Any suitable drive mechanism may be coupled to the trolley 206 and/or track 204 for moving the cover 202 between the retracted position and the deployed position. For example, a cable extends between an electrically operable motor and the trolley 206 so that, when the electrically operable motor is electrically operated, the motor imparts movement of the cable to impart movement of the trolley 206 along the track 204. That is, with the drive mechanism mounted inboard of the cover 202, the drive mechanism may pull the cable toward the drive mechanism to move the cover 202 from the deployed position toward the retracted position and the drive mechanism may release the cable to move the cover 202 from the deployed position toward the retracted position. The cover 202 may be biased toward the deployed position to urge the cover 202 over and along the lens 106 of the headlight 102. The drive mechanism may be coupled to both covers 202 so that the set of covers 202 are moved between the retracted position and the deployed position simultaneously.

Further, the track 204 is movable inward and outward (e.g., generally along the longitudinal axis 16 of the vehicle 10) to extend and retract the cover 202 relative to the headlight 102. That is, when the cover 202 is moved from the deployed position to the retracted position, the cover 202 is initially moved inward away from the front of the vehicle and toward the headlight 102 (e.g., by about 10 to 12 millimeters or more) to accommodate space behind the hood 12 so that the cover 202 can be moved laterally inboard and away from the headlight 102 to the retracted position behind the hood 12 of the vehicle 10. For example, when the cover 202 is moved from the deployed position toward the retracted position, the track 204 is first moved inward to move the cover 202 toward the headlight 102 and then the trolley 206 is moved along the track 204 to move the cover 202 laterally away from the headlight 102 and inboard of the headlight toward the longitudinal axis 16 of the vehicle 10 and behind the hood 12. When the cover 202 is moved from the retracted position toward the deployed position, the trolley 206 is first moved along the track 204 to move the cover 202 out from behind the hood 12 and laterally outboard from the longitudinal axis 16 toward the headlight 102 and then the track 204 is moved outward (i.e., toward the front of the vehicle) to move the cover 202 away from the headlight 102 and to a final position that is generally flush with the hood 12 and/or front fascia 14 of the vehicle 10. In some examples, the track 204 is moved inward or outward relative to the headlight 102 as the trolley 206 and cover 202 move along the track 204 relative to the headlight 102 to provide a smooth and continuous motion of the cover 202 between the retracted position and the deployed position.

Optionally, the track 204 is stationary or fixed relative to the vehicle 10 and the headlight 102 and provides a curved or angled path for the trolley 206 so that, as the trolley 206 travels along the track 204 to move the cover 202 between the deployed position and the retracted position, the cover 202 follows the curve or angle of the track 204 to move toward and away from the headlight 102. In other words, the track 204 may be curved or angled to guide movement of the trolley 206 and cover 202 in toward the headlight 102 and behind the hood 12 when moving from the deployed position toward the retracted position and to guide movement of the trolley 206 and cover 202 away from the headlight 102 and to the flush position with the hood 12 and/or front fascia 14 when moving from the retracted position toward the deployed position.

In some examples, the cover 202 includes a recessed edge or seal 210 that circumscribes the cover 202 so that, when the cover 202 is in the deployed position, the seal 210 engages an inner surface of the vehicle body at or near the headlight 102 to preclude moisture, debris and other contaminants from entering between the cover 202 and the headlight 102 and so that the outer surface 202a of the cover 202 appears continuous with the outer surface of the vehicle body.

Thus, the set of covers 202 in the deployed position extend along and over the headlights 102 to hide the headlights 102 from view and provide a continuous and smooth surface between the outer surface 14a of the front fascia 14 and the outer surface 12a of the hood 12. The covers 202 may be formed from the same material and/or outer surface finish as the hood 12 and the front fascia 14. For example, the covers 202 may be formed from a plastic or fiberglass material and painted to match the hood 12 and the front fascia 14. Optionally, the covers 202 may be formed from carbon fiber and/or have a carbon fiber outer appearance to match a carbon fiber hood 12 and/or carbon fiber front fascia 14. Further, a profile or shape of the cover 202 may be configured to substantially correspond to an outer profile or shape of the lens 106 of the headlight 102 so that the cover 202 conforms to and/or closely resembles the form of the headlight 102. Thus, the general contour or shape of the vehicle 10 is maintained whether the covers 202 are in the deployed position or the retracted position.

The covers 202 may move from the deployed position to the retracted position inboard of the headlights 102 and behind the hood 12 to conceal the covers 202 and expose the headlights 102. In some examples, the hood 12 includes a pocket or cavity or recessed portion at an inner surface configured to accommodate the covers 202 in the retracted position.

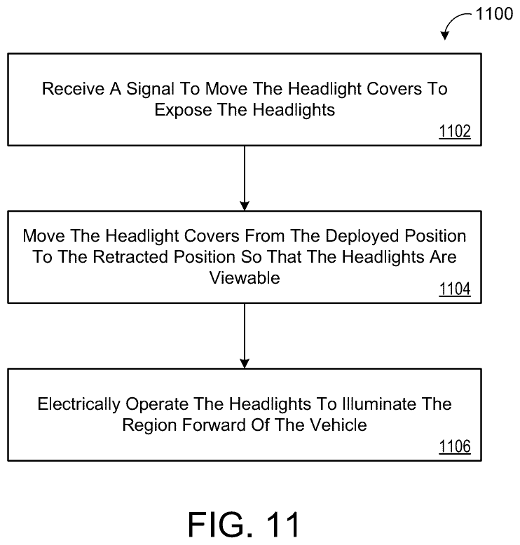

Referring to FIG. 1A, the vehicle 10 includes a control module or electronic control unit (ECU) 20 that includes data processing hardware 22 and memory hardware 24 in communication with the data processing hardware 22. The memory hardware 24 stores instructions that, when executed on the data processing hardware 22 cause the data processing hardware 22 to perform operations. For example, the memory hardware 24 stores instructions for controlling movement of the headlight covers 202 between the deployed position and the retracted position, such as in accordance with the method 1100 of FIG. 11 discussed further below.

The control module 20 may also control operation of the headlights 102, such as to energize the light source 104, adjust the headlights 102 between low beam and high beam, operate turn signal indicators and/or daytime running lights 108 at the vehicle 10, and the like. As shown, the daytime running lights 108 extend below the respective headlights 102 and between the headlights 102 and the front fascia 14. The covers 202 do not extend over the daytime running lights 108 so that the daytime running lights 108 are exposed and viewable when the cover 202 is in both the deployed position and the retracted position. Thus, the turn signal indicators and/or daytime running lights 108 may be operated and viewable with the headlights 102 hidden behind the covers 202.

Generally, the control module 20 controls movement of the headlight covers 202 so that the covers 202 are in the deployed position when the headlights 102 are not being operated (and not illuminating the region forward of the vehicle) and the covers 202 are in the retracted position when the headlights 102 are being operated to illuminate the region forward of the vehicle. For example, when the headlights 102 are in an off state and are not being electrically operated, the control module 20 instructs the covers 202 to move to the deployed position so that the covers extend over and along the headlights 102 to conceal the headlights 102 and provide a smooth and substantially continuous surface between the front fascia 14 and the hood 12 at the headlight region of the vehicle 10. In response to the headlights 102 being electrically operated in the on state, the control module 20 instructs the covers 202 to move to the retracted position to expose the headlights 102 and allow the headlights 102 to illuminate the region forward of the vehicle 10.

For example, the vehicle 10 may include automatic headlights 102 that are electrically operated in response to low ambient light levels at the vehicle 10. That is, the control module 20, in response to determining low levels of ambient light (e.g., based on processing of sensor data from an ambient light sensor at the vehicle 10 or based on processing of image data captured by a camera at the vehicle 10), moves the covers 202 from the deployed position to the retracted position and electrically operates the headlights 102 to emit light.

In some examples, the vehicle 10 includes one or more user actuatable inputs that, when operated by a user or driver of the vehicle 10, cause the covers 202 to move between the deployed position and the retracted position and/or the headlights 102 to operate to illuminate the region forward of the vehicle 10. For example, the user actuatable input operates the headlights 102 between at least an off/daytime running light mode where the headlights 102 are not operated and the daytime running lights 108 are operated and an on/low beam mode where the headlights 102 are operated. In response to the user selecting the off mode, the covers 202 are moved to the deployed position and the headlights 102 are not operated. When the user selects the on mode, the covers 202 are moved to the retracted position and the headlights 102 are operated.

Optionally, the user may provide an input to move the covers 202 between the deployed position and the retracted position regardless of whether the headlights 102 are being operated. For example, the user may provide an input to move the covers 202 from the deployed position to the retracted position with the headlights 102 not being operated, such as to wash the lens 106 of the headlights 102. Further, the covers 202 may move between the deployed position and the retracted position upon vehicle startup. That is, the covers 202 automatically move to the retracted positon when the vehicle is being operated.

In some implementations, the covers 202 move between the deployed position and the retracted position based on a user input at a key fob associated with the vehicle 10. For example, when the vehicle 10 is unlocked, the covers 202 move from the deployed position to the retracted position and, when the vehicle 10 is locked, the covers move from the retracted position to the deployed position.

FIG. 11 provides a flowchart of an exemplary arrangement of operations for a method 1100 of controlling operation of set of retractable covers 202. The data processing hardware 22 of the control module 20 may execute instructions stored on the memory storage 24 to cause the data processing hardware 22 to perform the operations for the method 1100. At operation 1102, the method 1100 includes receiving a signal to move the headlight covers 202 to expose the headlights 102. For example, the signal instructs the controller 20 to operate the headlights 102 based on low ambient light levels at the vehicle 10. At operation 1104, the method 1100 includes moving the set of retractable headlight covers 202 from the deployed position, where the covers 202 extend over and along the lens 106 of the headlights 102 of the vehicle 10 so that the headlights 102 are not viewable, to the retracted position, where the covers 202 are moved laterally away and inboard of the headlights 102 so that the headlights 102 are viewable. At operation 1106, the method includes electrically operating the light sources 104 of the headlights 102 to emit light through the lens 106 to illuminate a region forward of the vehicle 10 while the covers 202 are in the retracted position.

The terminology used herein is for the purpose of describing particular exemplary configurations only and is not intended to be limiting. As used herein, the singular articles “a,” “an,” and “the” may be intended to include the plural forms as well, unless the context clearly indicates otherwise. The terms “comprises,” “comprising,” “including,” and “having,” are inclusive and therefore specify the presence of features, steps, operations, elements, and/or components, but do not preclude the presence or addition of one or more other features, steps, operations, elements, components, and/or groups thereof. The method steps, processes, and operations described herein are not to be construed as necessarily requiring their performance in the particular order discussed or illustrated, unless specifically identified as an order of performance. Additional or alternative steps may be employed.

When an element or layer is referred to as being “on,” “engaged to,” “connected to,” “attached to,” or “coupled to” another element or layer, it may be directly on, engaged, connected, attached, or coupled to the other element or layer, or intervening elements or layers may be present. In contrast, when an element is referred to as being “directly on,” “directly engaged to,” “directly connected to,” “directly attached to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

The terms first, second, third, etc. may be used herein to describe various elements, components, regions, layers and/or sections. These elements, components, regions, layers and/or sections should not be limited by these terms. These terms may be only used to distinguish one element, component, region, layer or section from another region, layer or section. Terms such as “first,” “second,” and other numerical terms do not imply a sequence or order unless clearly indicated by the context. Thus, a first element, component, region, layer or section discussed below could be termed a second element, component, region, layer or section without departing from the teachings of the example configurations.

A number of implementations have been described. Nevertheless, it will be understood that various modifications may be made without departing from the spirit and scope of the disclosure. Accordingly, other implementations are within the scope of the following claims.

What is claimed is:

1. A vehicular headlight system of a vehicle, the vehicular headlight system comprising:
a headlight mounted on the vehicle, the headlight configured to emit light for illuminating a region forward of the vehicle; and
a cover movable relative to the headlight between:
a deployed position, where the cover extends over and along the headlight so that the headlight is not viewable from an exterior of the vehicle; and
a retracted position, where the cover is moved laterally away and inboard of the headlight so that the headlight is viewable from the exterior of the vehicle.

2. The vehicular headlight system of claim 1, wherein, when the cover is in the deployed position, an outer surface of the cover is substantially flush with an outer surface of a body portion of the vehicle.

3. The vehicular headlight system of claim 2, wherein, when the cover is moved from the deployed position to the retracted position, the cover is initially moved inward away from a front of the vehicle and toward the headlight, and then moved laterally away from the headlight to a position behind the body portion of the vehicle.

4. The vehicular headlight system of claim 3, wherein the body portion of the vehicle comprises a hood of the vehicle.

5. The vehicular headlight system of claim 1, wherein the cover is laterally movable relative to the headlight along a track.

6. The vehicular headlight system of claim 5, wherein, when the cover is moved from the deployed position to the retracted position, the track is initially moved away from the front of the vehicle and toward the headlight to move the cover toward the headlight, and then the cover is moved laterally along the track away and inboard of the headlight.

7. The vehicular headlight system of claim 1, wherein:
when the headlight is electrically operated in an on state to emit light, the cover is in the retracted position; and
when the light source is not electrically operated and in an off state, the cover is in the deployed position.

8. The vehicular headlight system of claim 1, wherein the cover is moved from the deployed position to the retracted position in response to the headlight being electrically operated.

9. The vehicular headlight system of claim 1, wherein the cover is movable between the deployed position and the retracted position based on a user actuatable input.

10. The vehicular headlight system of claim 1, wherein, with the headlight mounted on the vehicle, a daytime running light is mounted on the vehicle near the headlight, the daytime running light viewable when the cover is in the deployed position and the retracted position.

11. A vehicle comprising:
a headlight, the headlight comprising a lens and a light source that, when the light source is electrically operated, emits light through the lens to illuminate a region forward of the vehicle; and
a cover that is movable relative to the headlight between:
a deployed position, where the cover extends over and along the lens of the headlight so that the headlight is not viewable; and
a retracted position, where the cover is moved laterally away and inboard of the headlight so that the headlight is viewable.

12. The vehicle of claim 11, wherein, when the cover is in the deployed position, an outer surface of the cover is substantially flush with an outer surface of a body portion of the vehicle at or near the headlight.

13. The vehicle of claim 12, wherein, when the cover is moved from the deployed position to the retracted position, the cover is moved toward the headlight and moved laterally away from the headlight behind the body portion of the vehicle.

14. The vehicle of claim 13, wherein the body portion of the vehicle comprises a hood of the vehicle.

15. The vehicle of claim 11, wherein the cover is laterally movable relative to the headlight along a track.

16. The vehicle of claim 15, wherein, when the cover is moved from the deployed position to the retracted position, the track is moved toward the headlight to move the cover toward the headlight and the cover is moved laterally along the track away and inboard of the headlight.

17. The vehicle of claim 11, wherein:
when the light source is electrically operated, the cover is in the retracted position; and
when the light source is not electrically operated, the cover is in the deployed position.

18. The vehicle of claim 11, wherein the cover is moved from the deployed position to the retracted position in response to the headlight being electrically operated.

19. The vehicle of claim 11, wherein the cover is movable between the deployed position and the retracted position based on a user actuatable input.

20. The vehicle of claim 11, wherein a daytime running light is mounted at the vehicle near the headlight, the daytime running light viewable when the cover is in the deployed position and the retracted position.

21. A computer-implemented method when executed on data processing hardware causes the data processing hardware to perform operations comprising:
instructing a cover to move laterally away and inboard of a headlight from a deployed position to a retracted position, wherein:
the cover extends over and along the headlight mounted at a vehicle so that the headlight is not viewable when the cover is in the deployed position; and
the headlight is viewable when the cover is in the retracted position; and
electrically operating a light source of the headlight to emit light through a lens for illuminating a region forward of the vehicle while the cover is in the retracted position.

22. The method of claim 21, wherein, when the cover is in the deployed position, an outer surface of the cover is substantially flush with an outer surface of a body portion of the vehicle at or near the headlight.

23. The method of claim 22, wherein instructing the cover to move from the deployed position to the retracted position causes the cover to initially move toward the headlight and then move laterally away from the headlight behind the body portion of the vehicle.

24. The method of claim 23, wherein the body portion of the vehicle comprises a hood of the vehicle.

25. The method of claim 21, wherein the cover moves relative to the headlight along a track.

26. The method of claim 25, wherein instructing the cover to move from the deployed position to the retracted position causes the track to move toward the headlight to move the cover toward the headlight and the cover to move laterally along the track away and inboard of the headlight.

27. The method of claim 21, wherein, when the cover is in the deployed position, the light source is not electrically operated.

28. The method of claim 21, wherein the operations further comprise:
receiving an indication to switch operation of the headlight from an off state to an on state,
wherein instructing the cover to move from the deployed position to the retracted position is in response to receiving the indication to switch operation of the headlight from the off state to the on state.

29. The method of claim 21, wherein the operations further comprise:
receiving a user actuatable input,
wherein instructing the cover to move from the deployed position to the retracted position is based on receiving the user actuatable input.

30. The method of claim 21, wherein the vehicle comprises a daytime running light mounted at the vehicle near the headlight, the daytime running light viewable when the cover is in the deployed position and the retracted position.
